(19) United States
(12) Patent Application Publication
(10) Pub. No.: US 2016/0011744 A1
(43) Pub. Date: Jan. 14, 2016

(54) COMMUNICATION MANAGEMENT SYSTEM

(71) Applicant: ACR Development, Inc., Lynbrook, NY (US)

(72) Inventors: Anthony Christopher Roman, Rockville Centre, NY (US); Michael P. Hammond, JR., Port Jefferson Station, NY (US); Douglas J. Rose, New Rochelle, NY (US)

(21) Appl. No.: 14/329,774

(22) Filed: Jul. 11, 2014

(51) Int. Cl. G06F 3/0484; H04L 29/06; H04L 29/08; G06F 3/0481

(52) U.S. Cl. CPC G06F 3/04842; G06F 3/0481; H04L 65/403; H04L 67/18

(57) ABSTRACT

Methods, systems, and apparatus, including computer programs encoded on a computer storage medium, for automatically routing documents between users as milestones are completed. Recipients of the documents can be selected dynamically based on measures of their respective performance. Inbound and output communications to or from users can be dynamically muted to additional users based on tasks or task milestones.

### BACKGROUND

This specification relates to user communication and task management.

Task management is the process of managing tasks throughout their lifecycle. Typical project management software can manage estimation and planning, scheduling, cost control and budget for tasks within a project. Mobile device tracking refers to attaining the current geographic location of the mobile device by receiving location coordinates from the device.

### SUMMARY

In general, one aspect of the subject matter described in this specification can be embodied in methods that include the actions of obtaining a communication for a first user, wherein the communication is in electronic form and wherein the communication is associated with a respective time; selecting a first task of a plurality of tasks assigned to the first user for which the first user was most recently engaged, wherein the first task is associated with one or more milestones that each specify a respective goal to be accomplished by the first user by a respective date; associating the communication with the first task; identifying a different second user wherein the first task specifies a role for the second user in relation to at least one of the milestones of the first task; and notifying the second user of the communication. Other embodiments of this aspect include corresponding systems, apparatus, and computer programs.

These and other aspects can optionally include one or more of the following features. A task can be selected that the first user is currently engaged in, was most recently engaged in relative to the time, or was more frequently engaged in than other tasks of the plurality of tasks. The first task can be selected based on a sender or recipient of the communication. The first task can be selected based on a schedule for the first task and a current time, or selecting the first task based on a current geographic location of the first user. The first task can be selected based on content of the communication. The communication can be associated with a particular milestone of the first task. The role for the second user can be supervisory. A current geographic location of the first user can be associated with the communication. A description of the communication from the first user can be associated with the communication. Notifying the second user of the communication can comprise sending a message to the second user that identifies the first user and the communication. Notifying the second user of the communication can comprise sending the communication to the second user. Notifying the second user of the communication can comprise creating a second task and assigning the second task to the second user wherein the second task is associated with a milestone that requires the second user to review the communication. Notifying the second user of the communication can comprise generating an event for a second task assigned to the second user wherein the event identifies the communication. The communication can be incoming or outgoing. The communication can be a telephone call, an email message, or a text message. The communication can be received from one of a plurality of different devices. A fee for the communication can be calculated based on a duration of the communication and billing rate information associated with the first task.

In general, another aspect of the subject matter described in this specification can be embodied in methods that include the actions of determining that a first user has completed working on a document associated with a first task wherein the document is associated with a first document state; identifying a plurality of different second users wherein the first task specifies a respective role for each of the of second users; calculating a respective performance metric for each of the second users; selecting a second user based on the respective performance metrics; generating a second task for the selected second user wherein the second task requires the second user to review the document; and routing the document to the selected second user. Other embodiments of this aspect include corresponding systems, apparatus, and computer programs.

These and other aspects can optionally include one or more of the following features. Selecting the second user can comprise selecting the user having a highest performance metric. Calculating a respective performance metric for a particular user can be based on respective task states for tasks assigned to the particular user. Determining that the selected second user has completed the second task; identifying a third user wherein the second task specifies a role for the third user; and routing the document to the third user. The third user can be the first user. A particular document state indicates whether the document is not proofed, proofed pending invoice, proofed kicked back, invoiced but not sent, sent with invoice, sent without invoice, sent pending invoice, modified, rejected or approved. The first task can be associated with one or more milestones that each specify a respective goal to be accomplished by the first user by a respective date. A particular role is supervisory or non-supervisory. The role of the second user can be superior to a role of the first user.

Particular embodiments of the subject matter described in this specification can be implemented to realize one or more of the following advantages. The system described herein automatically tracks tasks assigned to employees and tracks employees' whereabouts in order to determine whether tasks are progressing according to schedules. When this is not the case, the system can modify or reassign tasks so that the progress of the tasks in the aggregate satisfies a performance requirement. Software installed on users' mobile devices (e.g., smart phones) can be used to track user locations and send the locations to the system for purposes of assessing users' task progressions. The software can also inform the user of their task schedule and progress. Documents or other work product can be automatically routed between users as milestones are completed. Recipients of the documents can be selected dynamically based on measures of their respective performance. Inbound and output communications to/from users can be dynamically routed to additional users based on tasks and/or task milestones.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for task management and employee tracking.

FIG. 2 illustrates example document work flow.

FIG. 3 is a flowchart of an example method for communication management.

FIG. 4 is a flowchart of an example method for document workflow.

### DETAILED DESCRIPTION

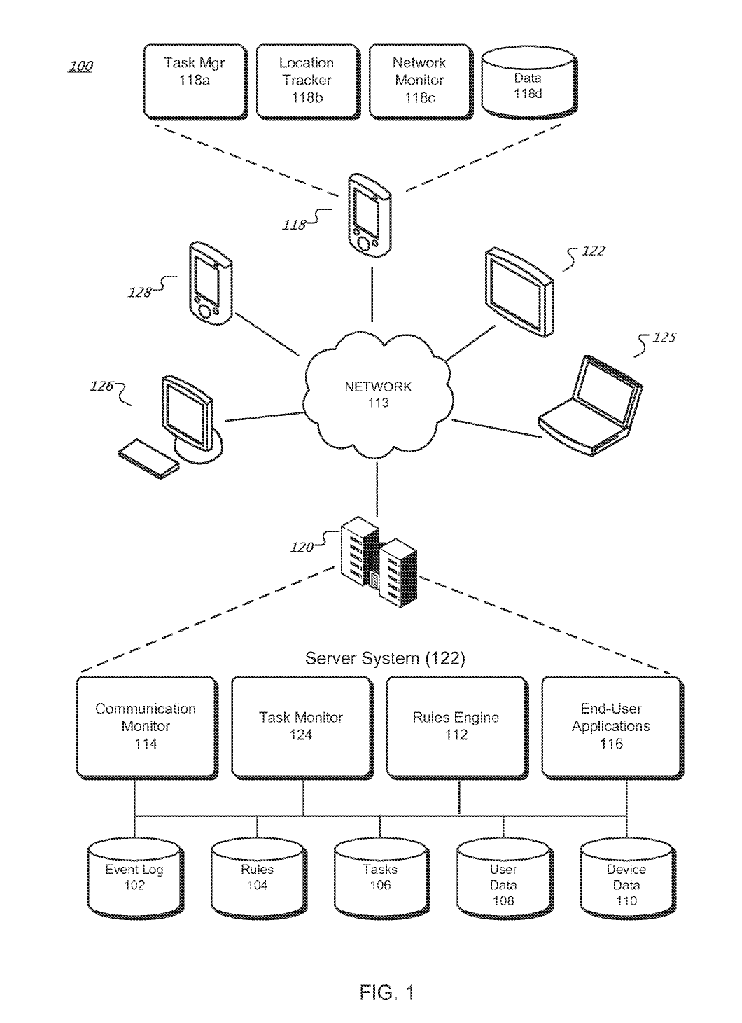

FIG. 1 illustrates an example system 100 for task management and employee tracking. A server system 122 provides task management and employee tracking functionality. The server system 122 comprises software components and databases that can be deployed at one or more data centers 120 in one or more geographic locations, for example. The server system 122 software components comprise a communication monitor 114, a task monitor 124, a rules engine 112, and end-user applications 116. The software components can comprise subcomponents that can execute on the same or on different individual data processing apparatus. The server system 122 databases comprise an event log 102, rules database 104, tasks database 106, user database 108, and device database 110. The databases can reside in one or more physical storage systems. The software components and data will be further described below.

The task monitor 124 is a software component that monitors the progress of each task assigned to a user (e.g., employee, contractor, subcontractor, client, etc.) of the server system 122. Task definitions are stored in tasks database 106. Tasks can have one or more of the properties in TABLE 1. Other task properties are possible.

TABLE 1

| Task Property | Description |
|---|---|
| Name | The name of the task. |
| Description | A description of the task and what it entails. |
| Priority | The task priority: critical, medium, low, or none. |
| State | The state of task progress based on milestone completion: completed, on track, |
| | ahead, behind, delinquent, or inactive. |
| User(s) or User | The names of users or types of users that can be assigned the task. For example, |
| Type(s) | the task can be assigned to users in a given company department, having a given |
| | job description, residing in a given geographic location, residing in a given time |
| | zone, having schedule availability, having a specific skill set, having a specific |
| | performance rating, or having a required license or credential. |
| Time Limit or End | The estimated time for completing the task or a date by which the task must be |
| Date | complete. |
| Travel | Whether user travel is required. |
| Milestone | A schedule for completing milestones required by the task. Each milestone can |
| Schedule | define a goal that should be accomplished by the schedule date and time of the |
| | milestone. For example, the goal could be a specific work product deliverable, |
| | a number of hours billed, or a geographic location that the user must be located |
| | in. |
| Roles | One or more users who can have a specific role for a given milestone or for the |
| | task as a whole. In some implementations, the role is supervisory such as an |
| | immediate supervisor or an higher level supervisor such as a manager or |
| | department lead. |
| Milestone | The completion status of each milestone. |
| Completion | |
| Billing | Billing arrangements for the task such as user billing rate(s), customer billing |
| information | arrangements (e.g., fixed fee, capped, hourly), and billing rate tiers. |
| License | State or federal licenses required by the user in order to perform the task. |
| Requirements | |
| State or Federal | State or federal rules that must be followed by the user performing the task. |
| Rules | |

Information for each user of the system is stored in the user database 108, including what tasks, if any, have been assigned to the user. The properties in TABLE 2 can be stored in the user database 108 for each user. Fewer or more user properties are possible.

TABLE 2

| User Property | Description |
|---|---|
| Name | The name of the user. |
| Job Description | A description of the user's job. |
| Department | The user's department within a company or organization. |
| Office Location | The geographic location of the user's home office. |
| Education | Any degrees held by the user. |
| Skill(s) | Any special skills the user has. |
| License(s) | Any federal or state licenses the user holds. |
| Language(s) | The languages the user speaks. |
| Tasks(s) | The names of tasks assigned to the user. |

An application such as a web-based application can be provided as an end-user application 116 to allow users define and modify task and user properties through a graphical user interface, for example. The end-user applications 116 can be accessed through the network 113 by users of client devices (e.g., client device 126).

The task monitor 124 monitors the progress of milestone completion for each assigned task by processing events in the event log 102 in order to maintain the current state of each task. An event is a collection of information generated by the system or by a user based on their activities. In further implementations, an event can be generated by an external system such as, for example, an employee time card system which tracks when users clock in and out or an employee telephone usage tracking system. The system 122 stores events in the event log 102. Each event can have two or more of the properties in TABLE 3. Other event properties are possible.

TABLE 3

| Event Property | Description |
|---|---|
| Time and Date | The time and date that the event was generated. |
| Source | The identity of the user or system component that caused the event to be |
| | generated. |
| User | The identity of the user that the event pertains to. This is an optional |
| | property. |
| Task | The task the event pertains to. This is an optional property. |
| Milestone | The milestone of the task that the event pertains to. This is an optional |
| | property. |
| Type | The type of event such as, for example, a user location event, a milestone |
| | status event, a device access event, etc. Other types of events are |
| | possible. (User geographic location tracking is described further below) |
| Data | Data for the event that depends on the event type. For example, user |
| | location event data will be the geographic location of the user, milestone |
| | status event data will indicate whether a milestone is completed, in |
| | progress, or late. Other types of data are possible. |

The communication monitor 114 receives location data from portable client devices through one or more data communication networks 113 such as the Internet, for example. The client devices (e.g., 128, 118, 122, 126, and 125) are data processing apparatus such as, for instance, smart phones, tablet computers, smart watches, smart glasses, laptop and portable computers, personal computers, and other data processing apparatus. Data describing devices assigned to users is stored in device database 110. The data can include the type of device, its operating system, its Internet Protocol address, the owner of the device, and so on. The client devices can be configured to track their geographic location over time and send location updates through the network 113 to the communication monitor 114. (Client device software components for location tracking are described further below.) The communication monitor 114 in turn generates user location events which are inserted into the event log. For example, a user location event could contain the following information:

Time and Date: 2:23 PM, Mar. 6, 2014

Source: Communication monitor

User: Frederick Dean

Type: User Location Event

Data: 3987 Oak Street heading South West at 32 miles per hour.

The location information received from a client device will comprise a timestamp and a location of the client device at the time corresponding to the time stamp. The location information can be in the form of a street address, latitude and longitude coordinates, or another form. In some implementations, the location information received from the client device includes the compass heading and speed of travel. In other implementations, the communication monitor 114 can deduce the compass heading and speed of travel by analyzing location information received from a particular client device over time.

In further implementations, if a task requires travel and a task milestone indicates a geographic location that the user must be in at a given time, the communication monitor 114 can predict the time that the user will arrive at the location and generate an event. The communication monitor 114 can identify such milestones in the task database 106 and find corresponding users from the user database 108 that have been assigned those tasks. Location information received from client devices of the users can then be used to generate predicted arrival times. By way of illustration, such an event comprise the following information:

Time and Date: 2:24 PM, Mar. 6, 2014

Source: Communication monitor

User: Frederick Dean

Task: Package Delivery

Milestone: Arrive at 3987 Oak Street, Pasadena, Calif. 91105.

Type: Predicted User Arrival

Data: 3:47 PM.

In some implementations, the communication monitor 114 can route communications among different users and automatically associate the communications with various attributes based on tasks the user is assigned to. Generally speaking, a communication is a telephone call, an email message, or a text message. Other forms of communication are possible. Inbound communications originate from remote systems and flow into the server system 122 through the communication monitor 114 before they are delivered to respective users. Likewise, outbound communications from different users flow through the communication monitor 114 before leaving the server system 122. In addition, communications between users of the system 100 are routed to or copied to the communication monitor 114. Systems that provide email, text and telephone services can be configured to route or copy all communications to the communication monitor 114.

The communication monitor 114 associates the current time with each communication it receives. In some implementations, a user that sends or receives a message can enter a description of the message, manually associate the message with a task, or both. Other information can be automatically associated with a communication such as, for example, the current geographic location of the sender or the receiver (e.g., based on location update events) and a task. The task is a task for which a user was most recently engaged such as the task that the user has most recently billed to or recorded time for, the task associated with a file or document currently accessed, most recently accessed, or most frequently accessed by the user, or the task can be determined based on a combination of these factors. The task can also be determined by content of the communication that identifies the task such as in a subject line of the communication or elsewhere in the content. The email address or identity of the recipient or the sender can also be used to determine the task. For example, the task associated with a previous communication can be associated with a new communication for the same sender or receiver. Alternatively, the task is based on a current location of the user if the task has a milestone requiring the user to be in that location. In further implementations, the communication can be associated with a milestone of the selected task, such as the mostly recently completed milestone or the next to be completed milestone. Once a task is associated with a communication a fee or charge for the communication can be determined based on billing information associated with the task and, optionally, the size or duration of the communication, or other attributes of the communication.

In some implementations, a user having a role for the task associated with the communication can be notified of the communication. For example, if a user has a supervisory role the communication monitor 114 can be copied on all communication for the task to the user or the user can be notified whenever there is a communication associated with the task. For example, the communication monitor 114 can create an event that triggers a rule which sends a message to the user. In further implementations, the communication monitor 114 can create a new task for the supervisor (or other role) which has a milestone for the supervisor to review or acknowledge the communication.

In some implementations, task and milestone information for a user can be sent to the user's client device by the task monitor 124. This allows the client device to keep the user up-to-date on task progress as well as allowing the user to indicate when a milestone is complete (for milestones that do not indicate completion by the user being located in a specific geographic location). For example, a graphical user interface (or other user interface) on the client device can provide an input method for the user to indicate that a milestone or task is complete. The client device then generates an event, such as the following, and sends the event to the server system 122 for insertion in the event log 102:

Time and Date: 11:35 PM, Mar. 2, 2014

Source: Mike Towers

User: Mike Towers

Task: Project Alpha

Milestone: Code and test rate exchange software module.

Type: Milestone status event

Data: Milestone completed.

The task monitor 124 monitors the progress of milestone completion for each assigned task by processing user location events, predicted user arrival events, and milestone completion events in the event log 102 in order to maintain the current completion state of each milestone and the current state (e.g., completed, on track, ahead, behind, delinquent or inactive) of each task assigned to a user. A “completed” task is a task where all of the milestones have been completed. An “on track” task is a task that is not completed but where the user has not fallen behind the milestone completion schedule. An “ahead” task is a task where the user has completed the most recent milestone ahead of schedule. A “behind” task is a task where the user has failed to complete the currently due milestone on schedule. A “delinquent” task is one where the user has failed to complete more than one milestone on schedule, including the most recent milestone. Finally, an “inactive” task is one in which a user has indicated that the task is not to be tracked. Other types of task states are possible. The task monitor 124 generates events in the event log 102 when task state changes. For example, the task monitor 124 can generate the following event indicating that Mike Towers has completed the task Project Alfa (assuming that Code and test rate exchange software module milestone was the last milestone):

Time and Date: 11:35 PM, Mar. 2, 2014

Source: Task Monitor

User: Mike Towers

Task: Project Alpha

Type: Task State Event

Data: Completed

The task monitor 124 can also calculate measures of the overall system performance based on that status of all active events in the system and generate events for these measures in the event log 102. For example, performance measure M1 is calculated as follows:

$$M 1 = \frac{O + A}{T}$$

where O is the number of on track tasks, A is the number of ahead tasks, and T is the total number of active tasks in the system. Performance measure M2 is calculated as follows:

$$M 2 = \frac{B + D}{T}$$

Where B is the number of behind tasks, D is the number of delinquent tasks. Yet another measure could be the average of M1 or M2 over time:

$$M 3 = \frac{{\sum }_{i = 1}^{n} M {1}_{i}}{n}$$

User-defined rules can be triggered based on the performance measure events in the event log 102 and take action to improve the performance of the system by changing and/or redistributing tasks among users. In further implementations, metrics M1, M2 and M3 can be calculated on a per user basis where O is the number of on track tasks for the user, A is the number of ahead tasks for the user, T is the total number of active tasks for the user, B is the number of behind tasks for the user, and D is the number of delinquent tasks for the user.

The rules engine 112 is the heart of the system and drives automatic task management through user-defined rules that perform actions automatically when the rules' conditions are satisfied. A rule can have the properties listed in TABLE 4, however other rule properties are possible. Rules are stored in the rule database 104. An application such as a web-based application can be provided as an end-user application 116 and offer the ability to define and modify rules through a graphical user interface, for example.

TABLE 4

| Rule Property | Description |
|---|---|
| Name | The name of the rule. |
| Description | A description of the rule and what it entails. |
| Task(s) | The task name or names to which the rule applies. |
| | Can be a wildcard which means the rule applies to any |
| | task. This is an optional property. |
| Milestone(s) | The task milestone(s) to which the rule applies. |
| | Can be a wildcard which means the rule applies to |
| | any milestone. This is an optional property. |
| Condition(s) | A set of one or more Boolean expressions that must be |
| | satisfied in order for the rule action(s) to be performed. |
| Action(s) | A set of one or more actions to perform when the rule |
| | conditions are satisfied. Rules can reassign tasks based |
| | on performance of system or a user, for example. |

In some implementations, the rules engine 112 scans the event log 102 for new events—events that it has not processed previously. For each new event, the rules engine 112 then identifies any rules in the rules database 104 that have a task, or task and milestone, that matches the new event's corresponding task or task and milestone. If there is a match, the rules engine 112 evaluates each identified rule's conditions to determine if they are satisfied. A condition is a set of one or more Boolean expression that, if evaluate to true, will cause the rules engine 112 to perform the associated action(s). The Boolean expression can refer to intrinsic data such as properties of tasks, users, and events. In addition, the Boolean expression can refer to extrinsic data such as the time of day, weather conditions in a given location, news reports, and so on.

For example, when satisfied the following rule notifies a dispatcher that the user assigned to the task is 30 minutes away from arriving at a given geographic location:

Name: Package Notification

Description: Notify dispatcher when employee is near drop off.

Task: Package Delivery

Milestone: Arrive at 3987 Oak Street, Pasadena. Calif. 91105.

Condition: Task.Predicted_arrival_time IS current_time+30 minutes

Action: NotifyDispatcher (“Task.user is 30 minutes away from delivering package.”)

The intrinsic data used in the condition of the above rule is the predicted arrival time for the task (Task.Predicted_arrival_time) which is determined using a Predicted User Arrival event from the event log 102 for the task and the user assigned to the task, and the identity of the user assigned to the task (Task.user) which is stored in the user database 108. A function NotifyDispatcher is defined by the system 122 and causes a message to be sent to the dispatcher (e.g., another user) associated with the task. The message can be in the form of a text message, an electronic mail message, a phone call, or other type of message.

By way of a further illustration, performance measurement events in the event log 102 can trigger rules that modify or reassign tasks in order to meet a system wide performance goal (e.g., M1, M2 or M3).

Name: Reassign Task

Description: Reassign a delinquent task to another user.

Task: Software Development

Milestone: Implement User API

Condition: System.M1<0.8 AND Task.state IS “delinquent”

Action: ReassignTask (Task, Task.user)

The above rule reassigns delinquent Software Development tasks when the system performance drops below 80%. The intrinsic data used in the condition of the above rule is the system performance measure M1 (System.M1) which is obtained from the event log 102, and the task state (Task.state) for the Software Development task assigned to the user (Task.user) which can be obtained from the user database 108. The ReassignTask function is defined by the system 122 and reassigns the task from the assigned user to a new user.

By way of a further example, the following rule modifies a milestone date for a task whose state is behind to give the user more time to complete the milestone:

Name: Push out behind milestone

Description: Reassign a delinquent task to another user.

Task: Software Development

Milestone: Implement User API

Condition: Task.state IS “behind”

Action: PushOutMilestone (Milestone, Task.user, 2 weeks)

The intrinsic data used in the condition of the above rule is the task state (Task.state) for the Software Development task assigned to the user (Task.user) which can be obtained from the user database 108. The PushOutMilestone function is defined by the system 122 and moves the milestone completion data ahead two weeks for the given user and task. Other types of rules are possible.

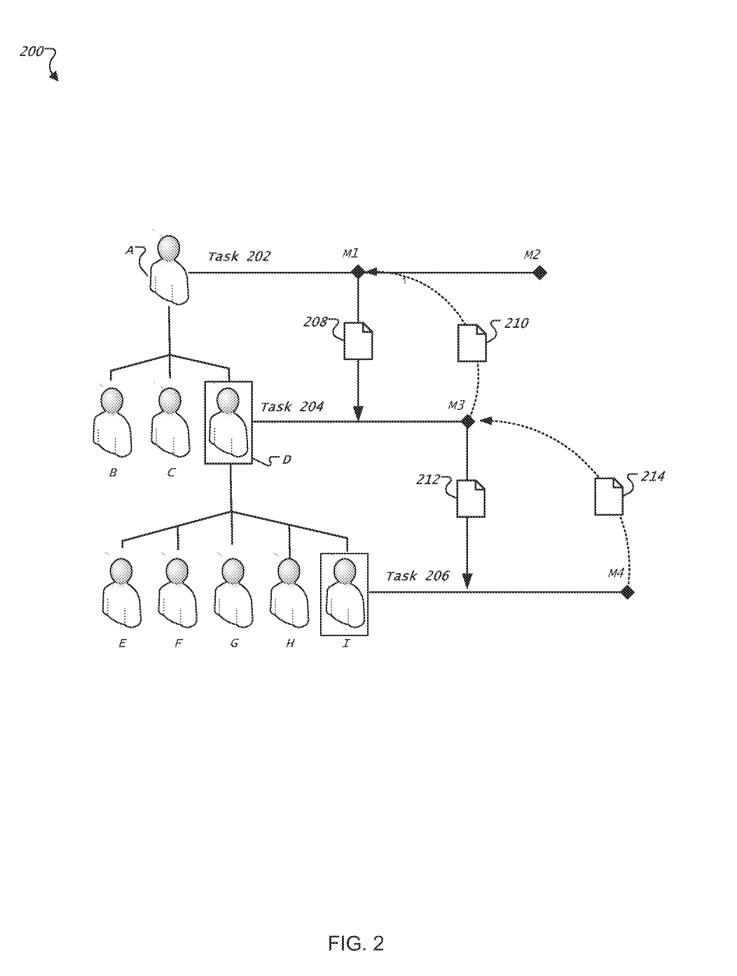

FIG. 2 illustrates example document work flow 200 which is an automated document routing and approval process implemented using task roles. User A is assigned task 202 which has two milestones: M1 and M2. Milestone M1 requires that the user create a document by a certain date or time and is achieved when user A has indicated completion of the milestone or when user A changes a document state associated with the document to indicate that the document has not yet been proofed. A particular document state indicates whether the document is not proofed, proofed pending invoice, proofed kicked back, invoiced but not sent, sent with invoice, sent without invoice, sent pending invoice, modified, rejected or approved. Other document states are possible. When milestone M1 is completed, the task monitor 124 determines if the document should be routed to another user for possible review or further processing. If there are users associated with the tasks that have roles indicating that they can review or further process the document (e.g., users B. C and D), the task monitor selects one of the users to route the document to. By way of illustration, the selected user is user D.

The task monitor 204 creates a new task 204 for the selected user D and then routes the document 208 created by user A to user D. The new task 204 has a milestone M3 which requires that user D review or process the document 208 by a certain date or time in the future. When milestone M3 is achieved, user D can optionally route the document 210 back to user A for further processing or the task monitor 204 can route the document to another user for subsequent processing. In the former case, user D can set the document state to indicate that the document is “proofed kicked back” or “rejected” and the task monitor 204 then modifies the task 202 to indicate that the milestone M1 is not complete. User A will have to complete milestone M1 again before the document can be processed further.

If user D approves the document and there are users associated with task 204 that have roles indicating that they can review or further process the document (e.g., users E, F, G, H, I), the task monitor selects one of the users to route the document to. By way of illustration, the selected user is user I. The task monitor 204 creates a new task 206 for the selected user I and then routes the document 212 to user I. The new task 206 has a milestone M4 which requires that user I review or process the document 212 by a certain date or time. When milestone M4 is reached, user I can optionally return the document 214 to user D for further processing or revision or the document can be routed to another user for subsequent processing.

In some implementations, the user to which to route a document to is selected based on one or more metrics (e.g., metrics M1, M2 and M3) calculated for the user. For example, the user having a highest value of metric M1 can be selected as the user to route a document to, or the user have a lowest value of metric M2 can be selected. Alternatively, the user to route a document to can be selected based on a metric calculated for the user and one or more skills the user may have. In a further implementation, the user to route a document to can be selected based on a metric and the document's status. Other ways of selecting users are possible.

As described above, user location tracking is performed by client devices (e.g., 128, 118, 122, and 125). A client device (e.g., client device 118) has software components installed on it for managing tasks assigned to the user of the client device and tracking the user's (i.e., the device's) location. The task manager 118a component provides a graphical user interface on the client device which allows the user to review milestone deliverables and schedules for their assigned tasks and can also automatically remind the user in advance when a scheduled milestone deadline is approaching. The task manager 118a also provides a graphical user interface (or other interface such as natural language) that allows a user to send a milestone status event to the server system 122 which will be entered into the event log by the task monitor 124. For example, the user can indicate through the user interface that a milestone has been completed or that a milestone was missed (and provide a reason).

Location tracker 118b is a software component that executes on the client device and that records the current geographic location information of the client device at different times and persistently stores the locations in data store 118d which retains its data across client device power cycles. In some implementations, the location tracker 118b treats the data store 118d as a stack with the most recently obtained geographic location information being “pushed” on top of the stack. In addition to location coordinates, the current geographical information can include the compass heading and speed of travel of the client device. In some implementations, the task manager 118a receives from the communication monitor 114 a set of one or more time periods during which the location of the client device can be tracked and the location tracker 118b only tracks location during those times (e.g., working hours). The location tracker 118b obtains the current geographic location from an operating system (OS) service of the client device. The OS obtains the current location using Global Positioning System (GPS) or base station triangulation. Location information can be obtained from the OS even if the client device is in “airplane mode” since only transmit functionality of the radios on the client device are disabled, not the receive functionality. When transmitters on the client device are disabled, the location tracker 118b continues to obtain location data and stores it in data store 118d.

Network monitor 118c is a software component that executes on the client device and that is responsible for sending location information to the communication monitor 114. When a transmitter is enabled on the client device the network monitor 118c will “pop” geographic location information off of the location stack in the data store 118d send the location information to the communication monitor 114. The network monitor 118c monitors the performance of the transmitter used to transmit location information to the communication monitor 114 and, if the performance is not acceptable either because the data rate is too slow or the channel has become unreliable, the network monitor 118c can use a different transmitter to transmit the location data. For example, if the cellular transmitter is performing poorly, the location information can be sent over the Wi-Fi transmitter (or vice versa).

The location tracker 118b utilize several parameters for its operation. The parameters are described in TABLE 5 below.

TABLE 5

| Parameter | Description |
|---|---|
| UPDATE_INTERVAL | A time threshold measured in seconds which is |
| | compared against a time of the location at the top of |
| | the location stack in the data store 118d. |
| DISTANCE_INTERVAL | A distance threshold measured in meters which is |
| | compared against the location at the top of the |
| | location stack in the data store 118d. |
| ACCEPTABLE_GPS_ACCURACY | A minimum accuracy threshold measured in meters. |
| ACCEPTABLE_NETWORK_ACCURACY | An minimum accuracy threshold measured in meters. |
| DISTANCE_BETWEEN_HITS | A variable measured in meters containing the distance |
| | between the current location and the location on the |
| | top of the stack. |
| BEARING_BETWEEN_HITS | A variable measured in degrees on a 360° scale |
| | containing the difference of magnetic bearing (or |
| | direction) between current location and the location on |
| | the top of the stack. |
| TIME_ELAPSED_BETWEEN_HITS | A variable measured in seconds containing the |
| | difference between the current location and the |
| | location on the top of the stack. |
| CURRENT_SPEED | A variable measured in meters/second containing the |
| | speed of current location. |

In some implementations, the location tracker 118b will discard location information obtained from the OS that does not satisfy accuracy thresholds. GPS locations having accuracies that do not exceed the ACCEPTABLE_GPS_ACCURACY are discarded (i.e., they are not stored in the data store 118d. Likewise, Wi-Fi triangulation locations having accuracies that do not exceed the ACCEPTABLE_NETWORK_ACCURACY are also discarded.

If a given geographic location has acceptable accuracy, then the location tracker 118b will determine whether or not the location should be pushed onto the location stack in the data store 118d based on an algorithm that decreases the amount of data transferred from the client device to the communication monitor 114. The algorithm reduces the use of client device's transmitter (and therefore increases battery life of the client device) and provides the communication monitor 114 with an easy to visualize path of travel by omitting redundant and unneeded location information. Based on the CURRENT_SPEED of the client device, the location tracker 118b performs operations in accordance with TABLE 6 below for location information obtained from the OS.

TABLE 6

| CURRENT_SPEED | Action Taken for Newly Obtained Location Information |
|---|---|
| 0 Miles per hour (MPH) | If the UPDATE_INTERVAL has past, the new location information |
| | is pushed on the location stack in the data store 118d, otherwise the |
| | new location information is discarded. |
| Greater than 0 MPH but less | If any of the following conditions are true, the new location |
| than or equal to walking | information is pushed on the location stack in the data store 118d, |
| speed | otherwise the new location information is discarded: |
| | The DISTANCE_INTERVAL threshold been passed; |
| | The UPDATE_INTERVAL has elapsed; or |
| | The BEARING_BETWEEN_HITS exceeded the threshold of |
| | the last location sent to the communication monitor 114 and |
| | the distance traveled since the last sent location is greater |
| | than the DISTANCE_INTERVAL. |
| Greater than walking speed | If any of the following conditions are true, the new location |
| | information is pushed on the location stack in the data store 118d, |
| | otherwise the new location information is discarded: |
| | The bearing of the current location has exceeded the |
| | BEARING_BETWEEN_HITS; or |
| | The UPDATE_INTERVAL has elapsed. |

In some implementations, the location tracker 118b is a supervisory or other special process in the mobile device OS that cannot be terminated by users of the device. For example, on mobile devices running the Android operating system, the location tracker 118b is programmed as a persistent foreground service which runs at a higher priority than normal application processes. This prevents the operating system from randomly killing the process when the device needs to acquire more resources.

In further implementations, the location tracker 118b is programmed to lock the client device if the user disables the location tracker 118b. The location tracker 118b can also send a notification message to communication monitor 114 indicating that the user has disabled location tracking. This can be recorded as an event in the event log 102 so that rules can perform actions on the occurrence of such events. For instance, the location tracker 118b can utilize an Android permission “device administrator” which grants it higher privileges than other applications and the ability to lock the client device, change its password, and erase the client device. In addition, the “device administrator” permission permits the location tracker 118b to detect when a user attempts to disable the location tracker 118b.

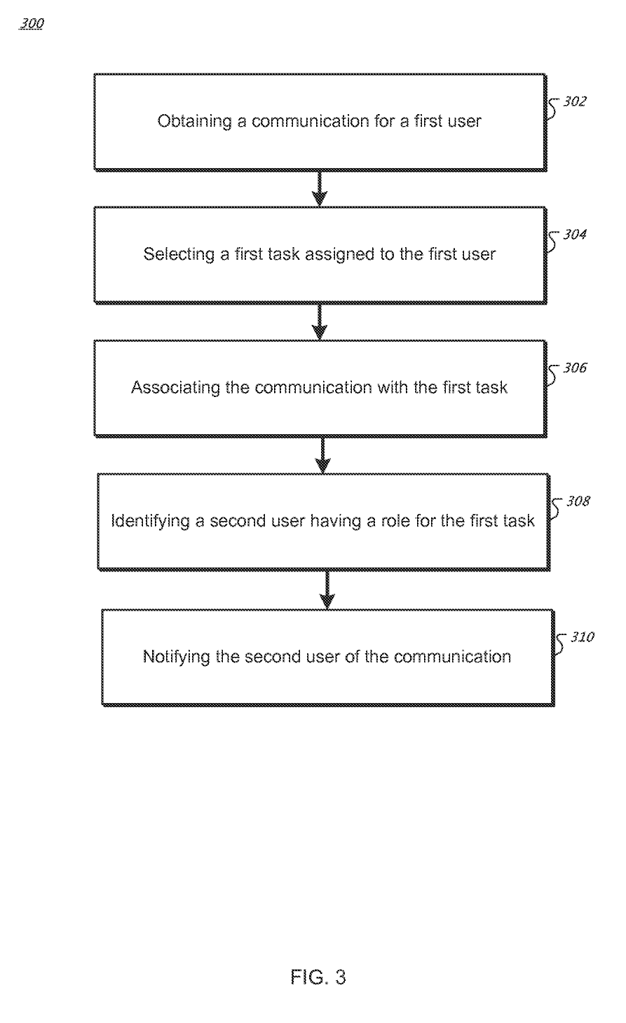

FIG. 3 is a flowchart of an example method for communication management. The method can be implemented using one or more data processing apparatus such as, for example, data processing apparatus that are part of the data center 120. The method steps can be performed by, for example, the communication monitor 114 or another component of the server system 122. The method begins by obtaining a communication for a first user, wherein the communication is in electronic form and wherein the communication is associated with a respective time (302). A first task of a plurality of tasks assigned to the first user is selected for which the first user was most recently engaged, wherein the first task is associated with one or more milestones that each specify a respective goal to be accomplished by the first user by a respective date (304). The first task is then associated with the communication (306). In some implementations, a second user is identified wherein the first task specifies a role for the second user in relation to at least one of the milestones of the first task (308). The second user is then notified of the communication (310).

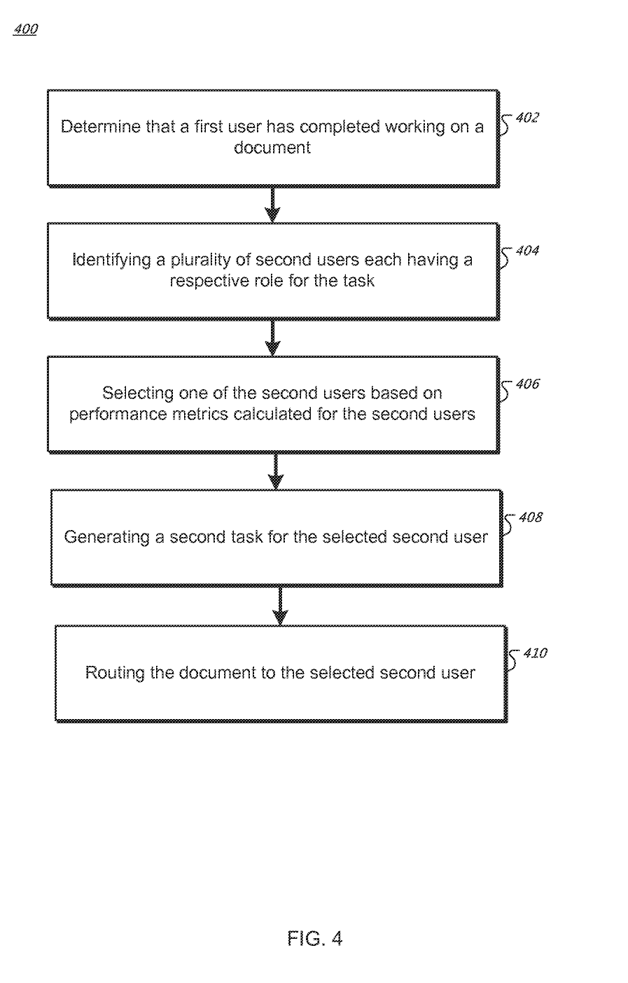

FIG. 4 is a flowchart of an example method for document workflow. The method can be implemented using one or more data processing apparatus such as, for example, data processing apparatus that are part of the data center 120. The method steps can be performed by, for example, the task monitor 114 or another component of the server system 122. The method begins by determining that a first user has completed working on a document associated with a first task wherein the document is associated with a first document state (402). A plurality of different second users are then identified wherein the first task specifies a respective role for each of the of second users (404). A respective performance metric is calculated for each of the second users (406). A second user is selected based on the respective performance metrics (408). A second task is generated for the selected second user wherein the second task requires the second user to review the document (408). The document is then routed to the selected second user (410). Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
performing by one or more data processing apparatus:
receiving a plurality of communications from respective senders, wherein each communication is in electronic form, is associated with a respective time, and designates a respective recipient of the communication;
selecting a task from a plurality of tasks assigned to the sender of a first of the communications, the selection of the task being based on a schedule for the task and a time of receipt of the first message, and associating the first communication with the selected task, wherein the selected task is associated with at least one milestone specifying a goal to be accomplished by the sender of the communication;
identifying a user, different from both the sender and the recipient of the first communication, wherein the task associated with the first communication specifies a role for the identified user in relation to at least one of the milestones of the task associated with the first communication; and
notifying the identified user of the first communication.

2. The method of claim 1, further comprising:
receiving another communication that designates another user as a recipient of the other communication; and
associating the other communication with a task that the other user is currently engaged in, was most recently engaged in relative to the time, or was more frequently engaged in than other tasks of a plurality of tasks.

3. The method of claim 1, further comprising:
receiving another communication that designates another user as a recipient of the other communication; and
associating the other communication with a task based on a sender of the other communication.

4. The method of claim 1, further comprising:
receiving another communication that designates another user as a recipient of the other communication; and
associating the other communication with a task based on a current geographic location of the other user.

5. The method of claim 1, further comprising:
receiving another communication that designates another user as a recipient of the other communication; and
associating the other communication with a task that is identified in content of the other communication.

6. The method of claim 1 wherein associating the first communication with the selected task further comprises associating the first communication with a particular milestone of the selected task.

7. The method of claim 1 wherein the role for the identified user is supervisory.

8. The method of claim 1 wherein associating the first communication with the selected task further comprises associating a current geographic location of the recipient of the first communication with the first communication.

9. (canceled)

10. The method of claim 1 wherein notifying the user of the first communication comprises sending a message to the user that identifies the recipient of the first communication and the first communication.

11. The method of claim 1 wherein notifying the user of the first communication comprises sending the first communication to the user.

12. The method of claim 1 wherein notifying the user of the first communication comprises creating another task and assigning the other task to the user wherein the other task is associated with a milestone that requires the user to review the first communication.

13. The method of claim 1 wherein notifying the user of the first communication comprises generating an event for another task assigned to the user wherein the event identifies the first communication.

14. (canceled)

15. The method of claim 1 wherein at least one of the received communications is a telephone call, an email message, or a text message.

16. The method of claim 1 wherein at least one of the received communications is received from one of a plurality of different devices.

17. The method of claim 1, further comprising:
determining a duration of the first communication;
calculating a fee based on the duration and billing rate information for the task associated with the first communication; and
associating the fee with the task associated with the first communication.

18-30. (canceled)

31. A system comprising:
one or more computers programmed to perform operations comprising:
receiving a plurality of communications from respective senders, wherein each communication is in electronic form, is associated with a respective time, and designates a respective recipient of the communication;
selecting a task from a plurality of tasks assigned to the sender of a first of the communications, the selection of the task being based on a schedule for the task and a time of receipt of the first message, and associating the first communication with the selected task, wherein the selected task is associated with at least one milestone specifying a goal to be accomplished by the sender of the communication;
identifying a user, different from both the sender and the recipient of the first communication, wherein the task associated with the first communication specifies a role for the identified user in relation to at least one of the milestones of the task associated with the first communication; and
notifying the identified user of the first communication.

32. The system of claim 31, further comprising:
receiving another communication that designates another user as a recipient of the other communication; and
associating the other communication with a task that the other user is currently engaged in, was most recently engaged in relative to the time, or was more frequently engaged in than other tasks of a plurality of tasks.

33. The system of claim 31, further comprising:
receiving another communication that designates another user as a recipient of the other communication; and
associating the other communication with a task based on a sender of the other communication.

34. The system of claim 31, further comprising:
receiving another communication that designates another user as a recipient of the other communication; and
associating the other communication with a task based on a current geographic location of the other user.

35. The system of claim 31, further comprising:
receiving another communication that designates another user as a recipient of the other communication; and
associating the other communication with a task that is identified in content of the other communication.

36. The system of claim 31 wherein associating the first communication with the selected task further comprises associating the first communication with a particular milestone of the selected task.

37. The system of claim 31 wherein the role for the identified user is supervisory.

38. The system of claim 31 wherein associating the first communication with the selected task further comprises associating a current geographic location of the recipient of the first communication with the first communication.

39. The system of claim 31 wherein notifying the user of the first communication comprises sending a message to the user that identifies the recipient of the first communication and the first communication.

40. The system of claim 31 wherein notifying the user of the first communication comprises sending the first communication to the user.

41. The system of claim 31 wherein notifying the user of the first communication comprises creating another task and assigning the other task to the user wherein the other task is associated with a milestone that requires the user to review the first communication.

42. The system of claim 31 wherein notifying the user of the first communication comprises generating an event for another task assigned to the user wherein the event identifies the first communication.

43. The system of claim 31 wherein at least one of the received communications is a telephone call, an email message, or a text message.

44. The system of claim 31 wherein at least one of the received communications is received from one of a plurality of different devices.

45. The system of claim 31, further comprising:
determining a duration of the first communication;
calculating a fee based on the duration and billing rate information for the task associated with the first communication; and
associating the fee with the task associated with the first communication.
